(19) United States
(12) Patent Application Publication
(10) Pub. No.: US 2005/0138769 A1
(43) Pub. Date: Jun. 30, 2005

(54) Self-securing drapery hooks

(76) Inventor: Lisa Granger, Mobile, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/026,836

(22) Filed: Dec. 30, 2004

Related U.S. Application Data
(60) Provisional application No. 60/533,493, filed on Dec. 31, 2003.

(51) Int. Cl. E05D 15/00

(52) U.S. Cl. 16/87.2

(57) ABSTRACT

Drapery hooks for mounting and suspending a drapery from a drapery rod are discribed. The drapery hook may include a pointed pin portion having an upper pointed end and a lower heel end and adapted for insertion into the drapery and a clamp portion extending upwardly from the lower heel end of the pin portion. The drapery hook may also include an upside down U-shaped portion extending from the upper end of the clamp portion, the upside down U-shaped portion adapted to hang over a drapery rod and be suspended therefrom. Additionally, the drapery hook may include a securing structure adapted to substantially secure a drapery ring in the upside down U-shaped portion. The securing structure may also be substantially immovable.

### CROSS-REFERENCE TO RELATED APPLICATION

This application claims priority to copending U.S. provisional application entitled, “SELF-SECURING DRAPERY HOOKS,” having Ser. No. 60/533,493, filed Dec. 31, 2003, which is entirely incorporated herein by reference.

### TECHNICAL FIELD

This disclosure is generally related to drapery hooks, and, more particularly, is related to self-securing drapery hooks.

### BACKGROUND

In the field of interior design, curtains and other window dressings can be paramount to a room's appeal. The curtains can be designed to complement or accentuate the colors of the walls, ceilings, floors, and furniture. While the right design of curtains, and curtain panels are a primary concern to interior design, many existing supported curtain panels suffer from any of a number of deficiencies.

Drapery hooks are used to secure the drapes in a desirable position. However, in the past, many drapery hooks often suffer from deficiencies. Many drapery hooks do not fully secure the drapery ring. This can result in the drapery rings becoming disengaged from the drapery hook. Disengagement of the drapery ring from the drapery hook is inconvenient and problematic.

Thus, a heretofore unaddressed need exists in the industry to address the aforementioned deficiencies and inadequacies.

### SUMMARY

Drapery hooks for mounting and suspending a drapery from a drapery rod are described. The drapery hook may include a pointed pin portion having an upper pointed end and a lower heel end and adapted for insertion into the drapery and a clamp portion extending upwardly from the lower heel end of the pin portion. The drapery hook may also include an upside down U-shaped portion extending from the upper end of the clamp portion, the upside down U-shaped portion adapted to hang over a drapery rod and be suspended therefrom. Additionally, the drapery hook may include a securing structure adapted to substantially secure a drapery ring in the upside down U-shaped portion. The securing structure may also be substantially immovable.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 illustrates one embodiment of a drapery hook with a pointed pin portion 10a.

FIG. 2 illustrates one embodiment of a drapery hook with a pointed pin portion 10b.

FIG. 3 illustrates one embodiment of a drapery hook with a pointed pin portion 10c.

FIG. 4 illustrates one embodiment of a drapery hook with a pointed pin portion 10d.

FIG. 5 illustrates one embodiment of a drapery hook with a pointed pin portion 10e.

FIG. 6 illustrates one embodiment of a drapery hook with a pointed pin portion

FIG. 7 illustrates one embodiment of a drapery hook with a pointed pin portion 10g.

FIG. 8 illustrates one embodiment of a drapery hook with a pointed pin portion 10h.

FIG. 9 is an illustrative example of a self-securing drapery hook having the securing structure 20i that is a removable structure having a first opening and a second opening.

FIG. 10 is similar to FIG. 6 with a securing structure 20j being shaped around clamp portion 16j.

### DETAILED DESCRIPTION

In accordance with the purpose(s) of the present disclosure, as embodied and broadly described herein, embodiments of the present disclosure, in one aspect, relate to self-securing drapery hooks. The self-securing drapery hooks are advantageous because an attaching structure such as a drapery ring is secured to the self-securing drapery hook by a securing structure. In contrast, previous drapery hooks did not secure the drapery ring so that upon moving the drapery the drapery rings became disengaged from the drapery hook. As is well known in the art, disengagement of the drapery ring from the drapery hook is inconvenient and problematic. Embodiments of the self-securing drapery hooks overcome at least some of the deficiencies of previous drapery hooks.

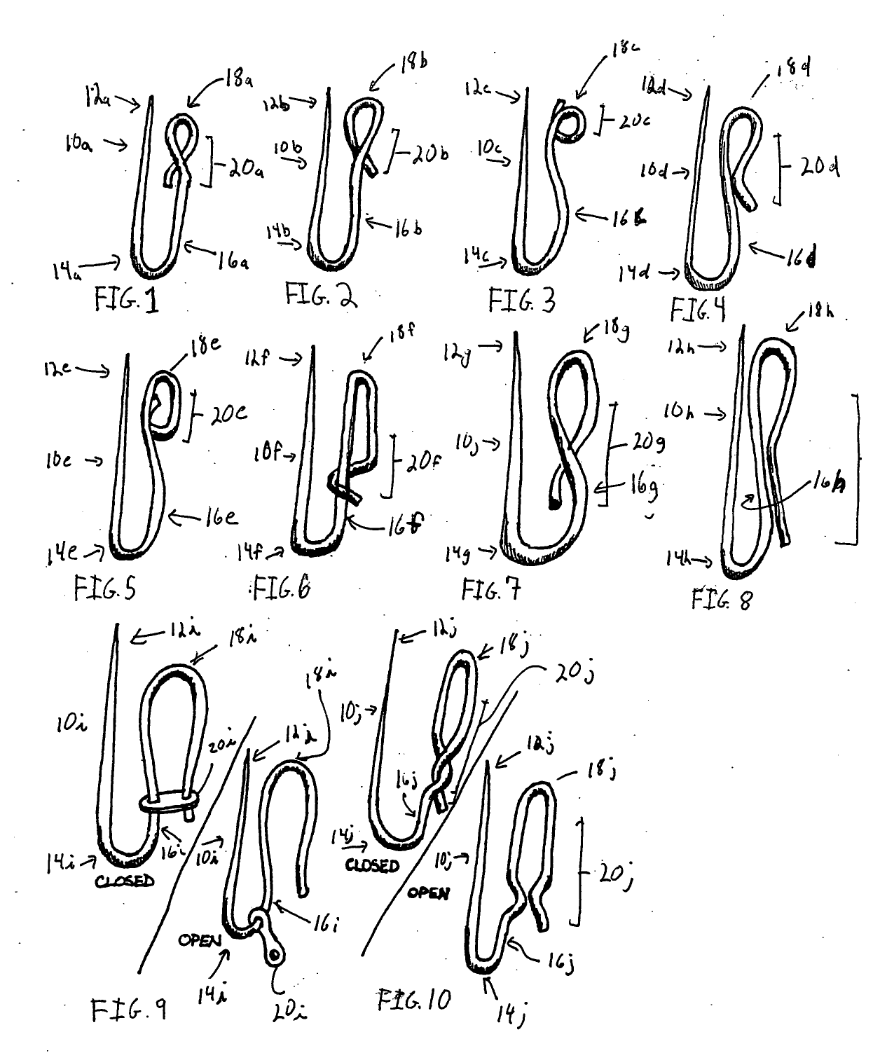

In general, the self-securing drapery hook includes a pointed pin portion having an upper pointed end and a lower heel end. The pointed pin portion is adapted for insertion (e.g., penetration into and/or through) into the drapery, curtain, or fabric. The lower heel end turns into a clamp portion extending upwardly from the lower heel end of the pin portion. The clamp portion turns into an upside down U-shaped portion extending from the upper end of the clamp portion in the downward direction. The upside down U-shaped portion is adapted to hang over a drapery rod and be suspended therefrom. As mentioned above, the self-securing drapery hooks include a securing structure that reversibly secures the drapery ring to the drapery hook. Additional details regarding the securing structure are described in FIGS. 1 through 10.

The self-securing drapery hook can be made of materials such as, but not limited to, metals, plastics, composites, and combinations thereof. The self-securing drapery hook can have dimensions such as about 1/16″ to ⅛″ thick by about 1″ to 2½″ long by about ¾″ to 1″ wide.

Now having described the embodiments of the self-securing drapery hook in general, FIGS. 1 through 10 describe some illustrative embodiments of the self-securing drapery hook. While embodiments of the self-securing drapery hook are described in connection with FIGS. 1 through 10 and the corresponding text and figures, there is no intent to limit embodiments of the self-securing drapery hook to these descriptions. On the contrary, the intent is to cover all alternatives, modifications, and equivalents included within the spirit and scope of embodiments of the present disclosure.

As shown in FIGS. 1 through 10, the design of some of the embodiments of the self-securing drapery hook can vary substantially. However, each self-securing drapery hook illustrated in FIGS. 1 through 10 includes a pointed pin portion 10a through 10j having an upper pointed end 12a through 12j, a lower heel end 14a through 14j, a clamp portion 16a through 16j, an upside down U-shaped portion 18a through 18j, and a securing structure 20a through 20j.

FIGS. 1, 2, 3, 5, and 7 are illustrative examples of self-securing drapery hooks having securing structures 20a, 20b, 20c, 20e, and 20g that form substantially closed loops that are adapted to secure the drapery ring to the self-securing drapery hook. The substantially closed loops are formed using an extension (securing structures 20a, 20b, 20c, 20e, and 20g) from the upside down U-shaped portion 18a, 18b, 18c, 18e, and 18g. The extensions 20a, 20b, 20c, 20e, and 20g cross the clamp portions 16a, 16b, 16c, 16e, and 16g (e.g., intersect the vertical plane of the clamp portion) to form substantially closed loops. It is not necessary for the extensions 20a, 20b, 20c, 20e, and 20g and the clamp portions 16a, 16b, 16c, 16e, and 16g to physically intersect one another. However, the extensions 20a, 20b, 20c, 20e, and 20g and the clamp portions 16a, 16b, 16c, 16e, and 16g can come into or forced to come into physical contact with one another to substantially close the loop. The extensions 20a, 20b, 20c, 20e, and 20g and/or the clamp portions 16a, 16b, 16c, 16e, and 16g can be curved in a manner to achieve the formation of the substantially closed loop. The extensions 20a, 20b, and 20g can be directed down towards the lower heel 14a, 14b, and 14g, or the extensions 20c and 20e can be directed up towards the upside down U-shaped portion 18c and 18e.

FIGS. 4 and 8 are illustrative examples of self-securing drapery hooks having securing structures 20d and 20h wherein at least a portion of the securing structure 20d and 20h is positioned substantially close to the clamp portion 16d and 16h but do not cross the clamp portion 16d and 16h. The securing structure includes an extension 20d and 20h from the upside down U-shaped portion 18d and 18h. At least a portion of the extension 20d and 20h is positioned substantially close and generally parallel with the clamp portion 16d and 16h to substantially inhibit the drapery ring from becoming disengaged from the self-securing drapery hook. The distance between the extension 20d and 20h and the clamp portion 16d and 16h should be such that the drapery ring does not become disengaged from the self-securing drapery hook. In this regard, the distance between the extension 20d and 20h and the clamp portion 16d and 16h should be less than the diameter of the drapery ring.

FIGS. 6 and 10 are illustrative examples of self-securing drapery hooks having securing structures 20f and 20j, where at least a portion of the securing structure 20f and 20j is wrapped or twisted around the clamp portion 16f and 16j or vice versa. The securing structure includes an extension 20f and 20j from the upside down U-shaped portion 18f and 18j. At least a portion of the extension 20f and 20j is wrapped around the clamp portion 16f and 16j or vice versa with one or more wraps around. The extensions 20f and 20j and/or the clamp portion 16f and 16j can be curved in a manner to achieve securing the extensions 20f and 20j and clamp portion 16f and 16j to one another. As shown in FIG. J, the extension 20j and the clamp portion 16j can be disengaged by simply squeezing the extension 20j and the clamp portion 16j.

More specifically, FIG. 1 illustrates one embodiment of a drapery hook with a pointed pin portion 10a. At the terminal end of the pointed pin portion 10a, the upper pointed end 12a forms a sharpened point that is adapted to penetrate into and/or through the drapery. At the opposite end of the pointed pin portion 10a is the lower heal end 14a. The clamp portion 16a is located adjacent the lower heal end 14a, which helps form the U-shaped portion 18a. The U-shaped portion 18a is located adjacent to securing the structure 20a. As shown, the U-shaped portion 18a and the securing structure 20a are shaped in a manner such that the terminal end of the drapery hook is located closer to the pointed pin portion 110a than is the clamp portion 16a.

FIG. 2 illustrates one embodiment of a drapery hook with a pointed pin portion 10b. At the terminal end of the pointed pin portion 10b, the upper pointed end 12b forms a sharpened point that is adapted to penetrate into and/or through the drapery. At the opposite end of the pointed pin portion 10b is the lower heal end 14b. The clamp portion 16b is located adjacent the lower heal end 14b, which helps form the U-shaped portion 18b. The U-shaped portion 18b is located adjacent to the securing structure 20b. As shown, the U-shaped portion 18b and the securing structure 20b are shaped in a manner such that the terminal end of the drapery hook is located farther from the pointed pin portion 10b than is the clamp portion 16b.

FIG. 3 illustrates one embodiment of a drapery hook with a pointed pin portion 10c. At the terminal end of the pointed pin portion 10c, the upper pointed end 12c forms a sharpened point that is adapted to penetrate into and/or through the drapery. At the opposite end of the pointed pin portion 10c is the lower heal end 14c. The clamp portion 16c is located adjacent the lower heal end 14c, which helps form the U-shaped portion 18c. The clamp portion 16c is substantially more bowed than the clamp portion 16a and 16b. This bowed shape of the clamp portion 16b results in the U-shaped portion 18c being located closer to the upper pointed end 12c than in FIGS. 1 and 2. The U-shaped portion 18c is located adjacent to the securing structure 20c. As shown, the U-shaped portion 18c and the securing structure 20c are shaped in a manner such that the terminal end of the drapery hook is pointed in substantially the same direction as the pointed end 12c, as opposed to pointed in a substantially opposite direction as in FIGS. 1 and 2.

FIG. 4 illustrates one embodiment of a drapery hook with a pointed pin portion 10d. At the terminal end of the pointed pin portion 10d, the upper pointed end 12d forms a sharpened point that is adapted to penetrate into and/or through the drapery. At the opposite end of the pointed pin portion 10d is the lower heal end 14d. The clamp portion 16d is located adjacent the lower heal end 14d, which helps form the U-shaped portion 18d. The U-shaped portion 18d is adjacent to the securing structure 20d. As shown, the U-shaped portion 18d and the securing structure 20d are shaped in a manner such that the terminal end of the drapery hook is pointed away from the pointed pin portion 10d. In addition, unlike in FIGS. 1, 2, and 3, the securing structure 20d never fully crosses the clamp portion 16d. Instead, the securing structure 20d resides adjacent to the clamp portion 16d.

FIG. 5 illustrates one embodiment of a drapery hook with a pointed pin portion 10e. At the terminal end of the pointed pin portion 10e, upper pointed end 12e forms a sharpened point that is adapted to penetrate into and/or through the drapery. At the opposite end of the pointed pin portion 10e is the lower heal end 14e. The clamp portion 16e is located adjacent the lower heal end 14e, which helps form the U-shaped portion 18e. The U-shaped portion 18e is located adjacent to the securing structure 20e. In FIG. 5 the securing structure 20e is curled back toward the U-shaped portion 18e, similar to FIG. 3. One difference lies in the size of the securing structure 20e, and the position of the terminal end of securing structure 20e.

FIG. 6 illustrates one embodiment of a drapery hook with a pointed pin portion 10f. At the terminal end of pointed pin portion 10f, upper pointed end 12f forms a sharpened point that is adapted to penetrate into and/or through the drapery. At the opposite end of the pointed pin portion 10f is the lower heal end 14f. The clamp portion 16f is located adjacent the lower heal end 14f, which helps form the U-shaped portion 18e. The U-shaped portion 18e is located adjacent to the securing structure 20e. As shown, the securing structure 20f defines an elongated aperture. Additionally, unlike in previous FIGS. 1 through 5, the securing structure 20f is folded from the backside of the clamp portion 16f (from this perspective) to the frontside of the clamp portion 16f.

FIG. 7 illustrates one embodiment of a drapery hook with a pointed pin portion 10g. At the terminal end of the pointed pin portion 10g, the upper pointed end 12g forms a sharpened point that is adapted to penetrate into and/or through the drapery. At the opposite end of the pointed pin portion 10g is the lower heal end 14g. The clamp portion 16g is located adjacent the lower heal end 14g, which helps form the U-shaped portion 18g. The U-shaped portion 18g is located adjacent to the securing structure 20g. As shown, the U-shaped portion 18g and the securing structure 20g are shaped in a manner such that the terminal end of the drapery hook is located closer to the pointed pin portion 10g than is the clamp portion 16g. FIG. 7 is similar to FIG. 1, except the clamp portion 16G is substantially more bowed than the clamp portion 16a, and the U-shaped portion 18g defines a larger aperture than defined by 18a.

FIG. 8 illustrates one embodiment of a drapery hook with a pointed pin portion 10h. At the terminal end of the pointed pin portion 10h, the upper pointed end 12h forms a sharpened point that is adapted to penetrate into and/or through the drapery. At the opposite end of the pointed pin portion 10h is the lower heal end 14h. The clamp portion 16h is located adjacent the lower heal end 14h, which helps form the U-shaped portion 18h. The U-shaped portion 18h is adjacent to the securing structure 20h. As shown, the U-shaped portion 18h and the securing structure 20h are shaped in a manner such that the terminal end of the drapery hook is pointed away from the pointed pin portion 10h. In addition, unlike in FIGS. 1, 2, and c, the securing structure 20h never fully crosses the clamp portion 16h. Instead, the securing structure 20h resides adjacent to the clamp portion 16h. Also, unlike in FIG. 4, the U-shaped portion 18h is located closer to the pointed pin portion 10h, and defines a larger aperture.

FIG. 9 is an illustrative example of a self-securing drapery hook having the securing structure 20i that is a removable structure having a first opening and a second opening. The clamp portion 16i receives the first opening and the upside down U-shaped portion 18i receives the second opening. When the clamp portion 16i and the upside down U-shaped portion 18i receive the securing structure 20i, the securing structure 201 substantially prevents the drapery ring from being disengaged from the drapery hook. Alternatively, the securing structure 20i may not be removable and/or the securing structure may not have openings but rather partial hooks or loops that can be used to secure the clamp portion 161 and the upside down U-shaped portion 18i.

FIG. 10, on the other hand, is similar to FIG. 6 with a securing structure 20j being shaped around the clamp portion 16j. However, as shown in FIG. 10, the clamp portion 16j is also shaped to more easily receive the terminal end of securing structure 20j. In open position, the securing structure 20j twists from frontside of the clamp portion 16j (viewed from this perspective), around to the backside of the clamp portion 16j. Securing the structure 20j is constructed such that tension secures the securing structure 20j in closed position. By “untwisting” the securing structure 20j, the drapery hook of FIG. 10 returns to open position.

It should be emphasized that the above-described embodiments of the present disclosure are merely possible examples of implementations, and are merely set forth for a clear understanding of the principles of this disclosure. Many variations and modifications may be made to the above-described embodiment(s) of the disclosure without departing substantially from the spirit and principles of the disclosure. For example, the extension and the clamp portions can be magnetically secured to one another. All such modifications and variations are intended to be included herein within the scope of this disclosure and protected by the following claims.

1. A drapery hook for mounting and suspending a drapery from a drapery rod, comprising:
a pointed pin portion having an upper pointed end and a lower heel end and adapted for insertion into the drapery;
a clamp portion extending upwardly from the lower heel end of the pin portion;
an upside down U-shaped portion extending from the upper end of the clamp portion, the upside down U-shaped portion adapted to hang over a drapery rod and be suspended therefrom; and
a securing structure adapted to substantially secure a drapery ring in the upside down U-shaped portion,
wherein the securing structure is substantially immovable.

2. The drapery hook of claim 1, wherein the securing structure is an extension of the upside down U-shaped portion, wherein the extension reversibly secures to the clamp portion so that the drapery ring is substantially secured in the upside down U-shaped portion.

3. The drapery hook of claim 1, wherein the securing structure is an extension of the upside down U-shaped portion, wherein the extension and the clamp portion are positioned substantially close to one another so that the drapery ring is substantially secured in the upside down U-shaped portion.

4. The drapery hook of claim 1, wherein the securing structure is an extension of the upside down U-shaped portion, wherein the extension and the clamp portion cross one another and are positioned substantially close to one another so that the drapery ring is substantially secured in the upside down U-shaped portion.

5. A drapery hook for mounting and suspending a drapery from a drapery rod, comprising:
a pointed pin portion having an upper pointed end and a lower heel end and adapted for insertion into the drapery;
a clamp portion extending upwardly from the lower heel end of the pin portion;
an upside down U-shaped portion extending from the upper end of the clamp portion, the upside down U-shaped portion adapted to hang over a drapery rod and be suspended therefrom; and
a securing structure adapted to substantially secure a drapery ring in the upside down U-shaped portion,
wherein the clamp portion is shaped to receive the securing structure.

6. The drapery hook of claim 5, wherein the securing structure is shaped to receive the clamp portion.

7. The drapery hook of claim 5, wherein the securing structure is an extension of the upside down U-shaped portion, wherein the extension reversibly secures to the clamp portion so that the drapery ring is substantially secured in the upside down U-shaped portion.

8. The drapery hook of claim 5, wherein the securing structure is an extension of the upside down U-shaped portion, wherein the extension and the clamp portion are positioned substantially close to one another so that the drapery ring is substantially secured in the upside down U-shaped portion.

9. The drapery hook of claim 5, wherein the securing structure is an extension of the upside down U-shaped portion, wherein the extension and the clamp portion cross one another and are positioned substantially close to one another so that the drapery ring is substantially secured in the upside down U-shaped portion.

10. A drapery hook for mounting and suspending a drapery from a drapery rod, comprising:
a pointed pin portion having an upper pointed end and a lower heel end and adapted for insertion into the drapery;
a clamp portion extending upwardly from the lower heel end of the pin portion;
an upside down U-shaped portion extending from the upper end of the clamp portion, the upside down U-shaped portion adapted to hang over a drapery rod and be suspended therefrom; and
a securing structure adapted to substantially secure a drapery ring in the upside down U-shaped portion,
wherein the securing structure is a removable structure having a first opening and a second opening, wherein the clamp portion receives the first opening and the upside down U-shaped portion receives the second opening so that a securing structure substantially prevents the drapery ring from being disengaged from the drapery hook.

11. The drapery hook of claim 10, wherein the securing structure is an extension of the upside down U-shaped portion, wherein the extension reversibly secures to the clamp portion so that the drapery ring is substantially secured in the upside down U-shaped portion.

12. The drapery hook of claim 10, wherein the securing structure is an extension of the upside down U-shaped portion, wherein the extension and the clamp portion are positioned substantially close to one another so that the drapery ring is substantially secured in the upside down U-shaped portion.
